(19) United States
(12) Patent Application Publication
(10) Pub. No.: US 2011/0027648 A1
(43) Pub. Date: Feb. 3, 2011

(54) Three-dimensional microbattery with tricontinuous components

(75) Inventors: Debra R. Rolison, Arlington, VA (US); Jeffrey W. Long, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the States of America, as represented by the Secretary of the Navy, Arlington, VA (US)

(21) Appl. No.: 12/818,812

(22) Filed: Jun. 18, 2010

Related U.S. Application Data
(60) Provisional application No. 61/220,439, filed on Jul. 30, 2009.

(51) Int. Cl. H01M 4/02; H01M 4/82

(52) U.S. Cl. 429/209; 29/623.5

(57) ABSTRACT

A three-dimensional battery architecture device comprising a porous substrate that has an aperiodic or random sponge network that forms the scaffolding of the first electrode (either cathode or anode) of a battery, a first coating deposited on the porous substrate, wherein the first coating is an electron insulating, ion-conducting dielectric material, and a second coating deposited in the remaining free volume, wherein the second coating is a an interpenetrating electrically conductive material that forms the second electrode (respectively anode or cathode) of the battery. A method of making a three-dimensional battery architecture device comprising depositing a first coating on a porous substrate wherein the porous substrate has an aperiodic or random sponge network and wherein the first coating forms the electrolyte of the battery and depositing a second coating on the first coating, wherein the second coating is a an interpenetrating electrically conductive material that forms the second electrode of the battery.

### CROSS-REFERENCE TO RELATED APPLICATIONS

This application is a non-provisional application of and claims priority to U.S. patent application No. 61/220,439, with a filing date of Jul. 30, 2009, the entirety of which is herein incorporated by reference.

### BACKGROUND OF THE INVENTION

(1) Field of the Invention

This disclosure describes ultraporous nanoarchitectures with bicontinuous pore and solid networks that are used as platforms to design battery architectures in three dimensions on the nanoscale with all three active components—anode, separator/solid electrolyte, cathode—tricontinuous.

(2) Description of Related Art

Multifunctional materials are prerequisite to electrochemical power sources, and for high performance they must exhibit an optimal combination of electronic conductivity, ionic conductivity, and facile mass transport of molecules and solvated ions.

Independent control of the elementary processes that give rise to the various forms of energy-relevant functionality is difficult with bulk materials. The materials science breakthroughs that are necessary to achieve the desired mission performance of the future will encompass nanoscience, with a particular emphasis on the ability to assemble nanoscale building blocks into the multifunctional architectures that are inherent to power sources.

The fundamental processes that produce or store energy can now be rethought in light of architectural nanoscience, i.e., the design and fabrication of three-dimensional (3-D) electrically conductive architectures from the appropriate nanoscale building blocks, including the use of “nothing” (void space) and deliberate disorder as design components.

The nature of the pore-solid nanoarchitecture of acrogels (derived from wet gels dried with essentially no pore collapse) and ambigels (derived from wet gels processed from nonpolar, low-surface-tension pore fluids) imparts new aspects to charge transport on the nanoscale.

Aerogels and ambigels innately meld high surface area expressed as a dendritic, self-wired, covalently bonded network of insertion-oxide nanoparticles with a continuous, interpenetrating mesoporous network that ensures rapid diffusional flux of reactants and products.

In rate-critical applications (sensing, energy-storage, energy-conversion, catalysis, synthesis), multifunctional materials expressed as ambigels or aerogels respond 10-1000 times faster than do nanostructures with 2-D or 3-D porosity. The quality of the plumbing, i.e., the continuity of the mesoporous network in three dimensions, is a critical component in establishing the high-rate character of these nanoarchitectures and in controlling high-quality chemical modification in the interior of the architecture.

Batteries, when optimally designed, scale so that they are not larger or heavier than the device they power. The recent advances in creating mesoscopic structures and devices, including microelectromechanical systems, have not been accompanied by comparable advances in scaling down their on-board source of power. The invention disclosed herein provides a new design strategy to transform the customary construction of standard batteries in order to take advantage of the smallness of scale of the device to be powered. Because these devices do not impose a high load on the power source, batteries can be devised that are not the ultimate in capacity or power density, but which permit more freedom in design.

### A BRIEF SUMMARY OF THE INVENTION

This disclosure describes ultraporous nanoarchitectures with bicontinuous pore and solid networks that are used as platforms to design battery architectures in three dimensions on the nanoscale with all three active components—anode, separator/solid electrolyte, cathode—tricontinuous.

The initial architectural scaffolding is sol-gel-derived; this wet, disordered gel is processed under conditions of low-to-minimal surface tension in order to remove the pore fluid without collapse, thereby retaining a through-continuous pore network with pores sized in the mesoporous range (2-50 nm).

The solid network comprises ˜10-nm domains of a high-surface-area intercalating oxide (cathode) or carbon (anode) onto which ˜10-nm thick films of a polymer is deposited (to serve as a separator).

The solid network may also comprise a good electronic conductor that serves as a massively parallel current collector onto which a conformal, ultrathin (<2-nm) coating is deposited that serves as a high-surface-area intercalating oxide (cathode) or carbon/oxide/sulfide/nitride/phosphate (anode) onto which ˜10-nm thick films of a polymer is deposited (to serve as a separator).

The remainder of the mesoporous volume provides a reservoir for a low melting-point metal (anode) or an intercalating oxide/sulfide/nitride/phosphate that serves as the counter electrode of the battery (i.e., as an anode or cathode as dictated by the composition of the original solid network).

### DESCRIPTION OF THE DRAWINGS

FIG. 1 illustrates a monolithic manganese oxide ambigel nanoarchitecture showing the oxide network onto which a conformal ultrathin polymer separator/electrolyte has been electrodeposited.

FIG. 2 is a schematic of the process whereby ultrathin, conformal, self-limiting polymer films are synthesized via oxidative electropolymerization of aryl monomers onto the surfaces of ultraporous electrically conductive nanoarchitectures.

FIG. 3 illustrates the electroreaction whereby ultrathin conformal polymer films are synthesized via oxidation of phenolate monomers onto ultraporous electrically conductive nanoarchitectures and some of the attributes of the resulting polymer.

FIG. 4 is a schematic for the two-point probe, solid-state measurements of ITO-supported, poly(phenylene oxide), PPO-coated manganese oxide nanoarchitectures as a MnO₂∥PPO∥Ga—In cell. The time response of the solid-state current is shown for stepping to potentials consistent with lithium-ion insertion into (+3 V) and de-insertion (+0.7 V) from MnO₂.

FIG. 5 illustrates a dark-field scanning transmission electron micrograph of a nanoarchitecture of MnO₂∥PPO∥RuO₂; elemental analysis of the region imaged via energy-dispersive spectrographic analysis; individual elemental maps for C (from PPO), Mn, and Ru; overlay (upper center) of C, Mn, and Ru.

### DETAILED DESCRIPTION OF THE INVENTION

This disclosure describes ultraporous nanoarchitectures with bicontinuous pore and solid networks that are used as platforms to design battery architectures in three dimensions on the nanoscale with all three active components—anode, separator/solid electrolyte, cathode—tricontinuous.

The initial architectural scaffolding is sol-gel-derived; this wet, disordered gel is processed under conditions of low-to-minimal surface tension in order to remove the pore fluid without collapse, thereby retaining a through-continuous pore network with pores sized in the mesoporous-to-small macroporous range, approximately 2 to about 50 nm and from 50 nm to 500 nm.

The solid network comprises ˜10-nm domains of a high-surface-area intercalating oxide (cathode) or carbon (anode) onto which ˜10-nm thick films of a polymer is deposited (to serve as a separator).

The solid network may also comprise a good electronic conductor that serves as a massively parallel current collector onto which a conformal, ultrathin (<2-nm) coating is deposited that serves as a high-surface-area intercalating oxide (cathode) or carbon/oxide/sulfide/nitride/phosphate (anode) onto which ˜10-nm thick films of a polymer is deposited (to serve as a separator).

The remainder of the mesoporous volume provides a reservoir for a low melting-point metal (anode) or an intercalating oxide/sulfide/nitride/phosphate that serves as the counter electrode of the battery (i.e., as an anode or cathode as dictated by the composition of the original solid network).

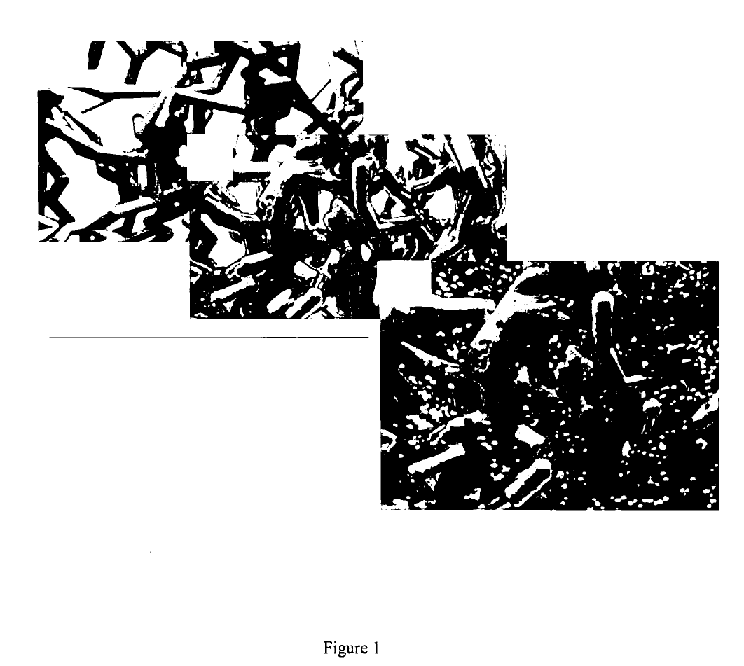

In the architecture illustrated in FIG. 1, the porous substrate has an aperiodic or random “sponge” network that may serve as the insertion cathode for a battery or as a massively parallel 3-D current collector onto which conformal, ultrathin coatings are deposited of a material that can function as an insertion anode or cathode.

The porous substrate can then coated with the electron insulating, ion-conducting dielectric material (e.g., electrolyte) and the remaining free volume is filled with an interpenetrating electrically conductive material that forms the second electrode of the battery (anode if the original scaffold or coated scaffold serves as the cathode of the battery; cathode if the original scaffold or coated scaffold serves as the anode of the battery).

The architecture represents a concentric electrode configuration wherein the ion-conducting dielectric material envelops the porous electrode scaffold while the other electrode fills the mesoporous and macroporous spaces and surrounds the ion-conducting dielectric material.

Short transport-path characteristics between the porous 3-D substrate (first electrode of the cell, e.g., cathode) and the second electrically conductive material (second electrode of the cell, e.g., anode) are preserved in this arrangement.

In addition, all battery components including the porous 3-D substrate, ion-conducting material, and second electrically conductive material are continuous throughout the sponge-like architecture.

Also disclosed herein is the sequential fabrication of a 3-D charge-insertion nanoarchitecture in which the protocol emphasizes the importance of the interpenetrating mesoporous network for achieving high-quality assembly of a tricontinuous composite of cathode, separator, and anode.

Three-dimensional charge-storage architectures can be created by conformal synthesis of appropriate dielectric and/or ionically conducting coatings within the confined spaces of a mesoporous nanoarchitecture as shown in FIG. 1.

It can be critical that these internal modification processes be conformal and that their growth be self-limiting.

Modifications of the high-surface-area nanoscopic solid must be achieved without plugging the through-connected porous network. A high-quality interfiling of the counter-insertion battery electrode cannot be achieved otherwise.

Examples demonstrated include using manganese dioxide as the rugged cation-insertion oxide platform in the form of supported films of MnOx ambigels onto which a polymer separator/electrolyte is electrodeposited in situ.

Manganese dioxide was the oxide of choice for the aerogel network that served as the intercalating cathode of the nanobattery. Manganese (IV) oxide is a particularly versatile composition in that numerous sol-gel preparations exist in the literature for this oxide in both its amorphous form (a-MnO₂) and its various crystalline (and porous crystalline) polymorphs. In general, amorphous materials provide higher practical insertion capacities than their crystalline forms. Unlike most methods of preparation, in which crystallite or domain size are difficult to control in a monodisperse fashion, the domain size in aerogels is ˜10 nm, resistant to sintering, and difficult to synthesize in either much smaller or larger domain sizes.

After a pinhole-free, ultrathin polymer barrier is formed conformally over the walls of the nanoarchitecture to serve as a physical and electronic barrier between the two nanoscopic electrodes of the battery, the remaining free volume is then filled with a nanoscopic material that functions as an insertion counter electrode.

The full 3-D realization on the nanoscale of the components required for the nanobattery concept has been demonstrated by synthesizing nanoparticles of disordered, anhydrous RuO₂, within the polymer-coated porous oxide nanoarchitecture. Although a non-traditional battery material, nanoscopic RuO₂ has been shown to reversibly insert lithium-ions, especially when the oxide is nanoscopic and disordered.

Example of creation of an electron-insulating, lithium-ion-conducting ultrathin polymer separator.

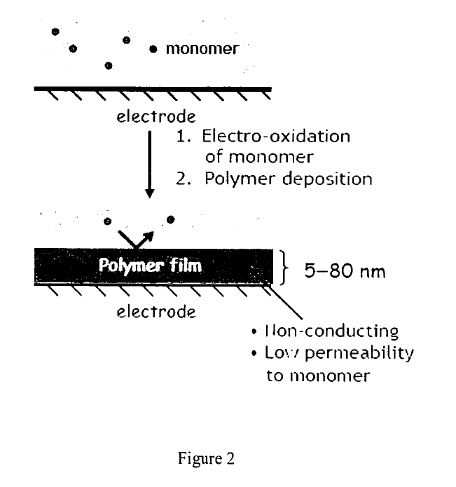

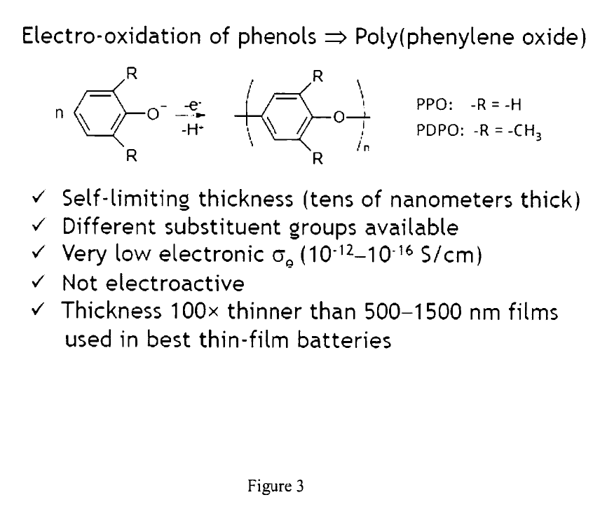

The quality of the plumbing in the manganese oxide nanoarchitecture, i.e., the continuity of the mesoporous network in three dimensions, is critical in order to maintain control of component assembly en route to a 3-D nanobattery. The electro-oxidation of phenol and 2,6-dimethylphenol in basic methanol or acetonitrile proceeds at MnOx ambigel films as it does at planar electrodes via self-limiting growth, as shown in FIG. 2, to generate poly(phenylene oxide)-based films that are tens of nanometers thick, highly electronically insulating, and with bulk-like dielectric strengths, as shown in FIG. 3.

Ions can then be incorporated within the electrodeposited films by either solvent casting methods using nonaqueous lithium electrolytes or co-electro-oxidizing substituted phenols with ionic functionality.

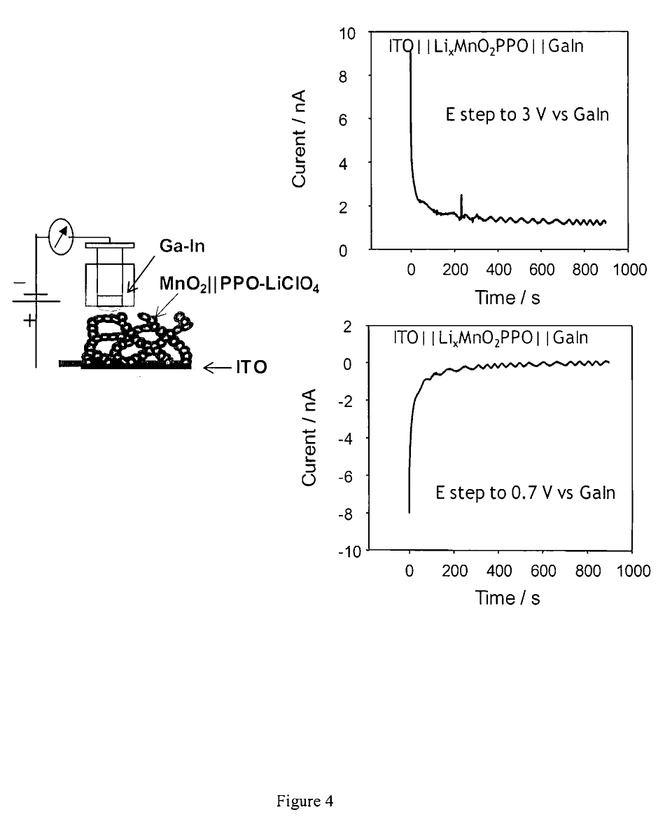

The AC impedance measurements made on ITO (indium-doped tin oxide, a conducting, transparent glass) similarly modified with poly(phenylene oxide)-based coatings verifies that the electrodeposited poly(phenylene oxide)-based films act as a dielectric, but convert to an impedance response characteristic of ion transport after incorporating mobile lithium ions. Two-point probe DC measurements, as shown in FIG. 4, demonstrate that Li ions undergo solid-state transport through the ultrathin electrodeposited polymer and insert/de-insert into the birnessite-type MnOx nanoarchitecture and the Ga—In counter electrode.

The nanoarchitectures are characterized at each stage (electrode scaffold; polymer-coated electrode; tricontinuous assembly of cathode∥polymer separator∥anode) by electrochemical, physical, structural, and microscopic methods. This battery of techniques establishes the physicochemical nature of the standard battery components (insertion cathode, polymer separator/electrolyte, and insertion anode) when synthesized as (or within) the mesoporous-to-macroporous nanoarchitecture.

An example of creation of the full battery.

The polymer-coated MnO₂ nanoarchitecture can then be infiltrated with a counter electrode by the autocatalytic deposition of RuO₂ from a solution of RuO₄ in hexane or pentane under cryogenic conditions.

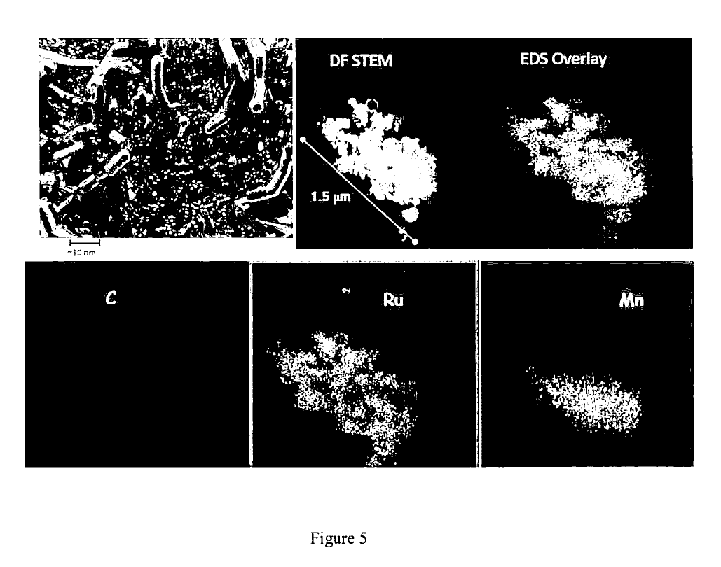

Transmission electron microscopy demonstrates that the polymer and RuO₂ are conformally integrated throughout the mesoporous MnO₂ matrix. Energy-dispersive X-ray spectroscopy (EDS) was used to obtain elemental maps for manganese, carbon, and ruthenium present in a piece of the tricontinuous structure (MnO₂∥PPO∥RuO₂ flaked off its ITO support) that corresponds to a dark-field image obtained with scanning transmission electron microscopy, as shown in FIG. 5. The overlay of the EDS elemental maps reveals that the polymer and RuO₂ are dispersed on the MnO₂ and demonstrates that both the polymer and RuO₂ penetrate the mesoporous structure of the MnO₂ architecture. Solid-state impedance measurements on planar ITO∥PPO∥RuO₂∥GaIn demonstrate that the deposition of RuO₂ can be made without electrically shorting the opposing electrodes.

The MnO₂∥polymer∥RuO₂ nanoarchitecture described in this disclosure is a tricontinuous sponge geometry that represents an integrated, tricontinuous nanocomposite in which the insertion anode and cathode are within nanometers of each other and separated by a solid polymer containing mobile lithium ions, but no plasticizing solvents.

The successful protocols described above for modification of surfaces under confinement furthers our ability to fabricate solid-state devices where components are integrated on the nanoscale and result in electrochemical systems with improved performance.

An immediate benefit of nanoscale (5- to 30-nm thick) solid polymer electrolytes is significantly improved rate capabilities for charge transport.

Polymers with even modest lithium conductors provide minimal resistance when only tens of nanometers thick.

The typical nanocrystalline, mixed-conducting oxides of interest in electrical and electrochemical applications are used as non-bonded nanoparticles that amplify grain-boundary contributions and create large charge-transfer resistances that can limit performance. Non-bonded (non-networked) nanoparticles of mixed-conducting character typically are materials of modest electron conductivity and require addition of electron-conducting powders (e.g., carbon powders or nanotubes or nanofibers) and a polymer binder to form the composite electrode. The continuous, covalently linked solid network in aerogels and ambigels eliminates these boundaries so that these materials electrically respond as an uninterrupted fractal network. This disclosure concerns aerogel-based nanoarchitectures, but can be extended to other through-porous conductive architectures that are sol-gel-derived or not.

Alternatives to this disclosure include other three-dimensional electrode geometries that are based on arrays of rod-shaped electrodes with features that are typically on a length scale of 1 micrometer or greater. In such cases the electrode arrays may comprise either the anode or cathode, with the interstitial space filled by electrolyte and opposing electrode phase, or alternatively, interdigitated arrays of alternating cathode and anode rods separated by an electrolyte phase may serve as a complete 3-D battery. Such 3-D battery designs offer significant advantages over conventional 2-D thin-film batteries.

The above description is that of a preferred embodiment of the invention. Various modifications and variations are possible in light of the above teachings. It is therefore to be understood that, within the scope of the appended claims, the invention may be practiced otherwise than as specifically described. Any reference to claim elements in the singular, e.g., using the articles “a,” “an,” “the,” or “said” is not construed as limiting the element to the singular.

What is claimed is:

1. A three-dimensional battery architecture device, comprising:
a porous substrate that has an aperiodic or random sponge network that forms a first electrode of a battery;
a coating deposited on the porous substrate,
wherein the coating is an electron insulating, ion-conducting dielectric material that forms the electrolyte of the battery; and
a further coating deposited in the remaining free volume,
wherein the further coating is a an interpenetrating electrically conductive material that forms a second, countering electrode of the battery.

2. The three-dimensional battery architecture device of claim 1 wherein the pores are from about 2 to about 50 nm.

3. The three-dimensional battery architecture device of claim 1 wherein the device is sol-gel derived.

4. The three-dimensional battery architecture device of claim 2 wherein the network is about 10-nm domains of an intercalating oxide material.

5. The three-dimensional battery architecture device of claim 4 wherein the first coating deposited on the porous substrate is an electron insulating, ion-conducting dielectric polymer having a thickness of about 10 nm.

6. The three-dimensional battery architecture device of claim 5 wherein the further coating deposited in the remaining free volume is a low melting point metal that forms the anode of the battery.

7. A three-dimensional battery architecture device, comprising:
a cathode defined by a nanoscale porous substrate that has an aperiodic or random sponge network;
a solid electrolyte defined by a first coating deposited on the porous substrate,
wherein the first coating is an electron insulating, ion-conducting dielectric material;
an anode defined by a second coating deposited on the first coating,
wherein the second coating is a an interpenetrating electrically conductive material; and
wherein the anode, solid electrolyte and cathode are tricontinuous.

8. The three-dimensional battery architecture device of claim 7 wherein the cathode defined by a nanoscale porous substrate that has an aperiodic or random sponge network is one selected from the group consisting of an aerogel, ambigel, and nanofoam.

9. The three-dimensional battery architecture device of claim 8 wherein the cathode defined by a nanoscale porous substrate that has an aperiodic or random sponge network has pores of from about 2 to about 50 nm.

10. The three-dimensional battery architecture device of claim 9 wherein the device is sol-gel derived.

11. The three-dimensional battery architecture device of claim 10 wherein the network is about 10-nm domains of an insertion oxide material.

12. The three-dimensional battery architecture device of claim 11 wherein the first coating deposited on the porous substrate is an electron insulating, ion-conducting dielectric polymer having a thickness of about 10 nm.

13. The three-dimensional battery architecture device of claim 12 wherein the second coating deposited in the remaining free volume is either a low melting point metal or a colloidal insertion oxide/sulfide/nitride/phosphate that forms the anode of the battery.

14. A three-dimensional battery architecture device, comprising:
a massively parallel 3-D electron-conducting scaffold (current collector) defined by a nanoscale porous substrate that has an aperiodic or random sponge network;
a conformal ultrathin, about 10-20 nm thick, coating deposited at the walls of the 3-D ultraporous current collector that serves as the first electrode (either cathode or anode) of the tricontinuous 3-D battery;
a solid electrolyte defined by a further coating deposited on the electrode-coated porous substrate, wherein the further coating is an electron insulating, ion-conducting dielectric material; and
a counter, second electrode (respectively either anode or cathode) defined by an additional coating deposited on the electrolyte/separator coating, wherein the additional coating is an interpenetrating electrically conductive material;
wherein the anode, solid electrolyte, cathode, and initial 3-D current collecting scaffold are tricontinuous.

15. The three-dimensional battery architecture device of claim 14 wherein the massively parallel 3-D electron-conducting scaffold defined by a nanoscale porous substrate that has an aperiodic or random sponge network is an aerogel or ambigel or nanofoam and wherein the massively parallel 3-D electron-conducting scaffold defined by a nanoscale porous substrate that has an aperiodic or random sponge network has pores of from about 20 nm to about 500 nm.

16. The three-dimensional battery architecture device of claim 15 wherein the device is sol-gel derived.

17. The three-dimensional battery architecture device of claim 16 wherein the network is conformally coated with about 10-nm to about 20-nm domains of an-insertion material that serves as the active cathode material.

18. The three-dimensional battery architecture device of claim 17 further including a further coating deposited on the porous substrate comprising an electron insulating, ion-conducting dielectric polymer having a thickness of about 10 nm to about 50 nm.

19. The three-dimensional battery architecture device of claim 18 wherein an additional coating deposited in the remaining free volume is either a low melting point metal or a colloidal insertion oxide/sulfide/nitride/phosphate that forms the anode of the battery.

20. A method of making a three-dimensional battery architecture device, comprising:
depositing a first coating on a porous substrate wherein the porous substrate has an aperiodic or random sponge network that forms the cathode of a battery and wherein the first coating is an electron insulating, ion-conducting dielectric material that forms the electrolyte of the battery; and
depositing a second coating on the first coating and in the remaining free volume, wherein the second coating is a an interpenetrating electrically conductive material that forms the anode of the battery.

21. The method of making a three-dimensional battery architecture device of claim 20 wherein the cathode defined by a nanoscale porous substrate that has an aperiodic or random sponge network is an aerogel or ambigel or nanofoam and wherein the cathode defined by a nanoscale porous substrate that has an aperiodic or random sponge network has pores of from about 2 to about 50 nm.

22. The method of making a three-dimensional battery architecture device of claim 21 wherein the device is sol-gel derived.

23. The method of making a three-dimensional battery architecture device of claim 22 wherein the network is about 10-nm domains of an insertion oxide material, wherein the first coating deposited on the porous substrate is an electron insulating, ion-conducting dielectric polymer having a thickness of about 10 nm and wherein the second coating deposited in the remaining free volume is either a low melting point metal or a colloidal insertion oxide/sulfide/nitride/phosphate that forms the anode of the battery.
